(19) United States
(12) Patent Application Publication
(10) Pub. No.: US 2022/0213915 A1
(43) Pub. Date: Jul. 7, 2022

(54) NAIL, IN PARTICULAR FOR USE IN A NAIL SETTING DEVICE

(71) Applicant: Raimund Beck Nageltechnik GmbH, Mauerkirchen (AT)

(72) Inventor: Stefan SIEMERS, Burghausen (DE)

(21) Appl. No.: 17/564,841

(22) Filed: Dec. 29, 2021

(30) Foreign Application Priority Data
Jan. 7, 2021 (EP) 21150547.4

(51) Int. Cl. F16B 15/02; F16B 15/08

(52) U.S. Cl. CPC F16B 15/02; F16B 15/08

(57) ABSTRACT

Nail, in particular for use in a nail setting device, of an exclusively or predominantly ligno-cellulosic material and has a nail shaft (2) defining a nail axis (X), a nail tip (3) arranged at the front end of the nail shaft (2) and a nail head (4) arranged at the rear end of the nail shaft (2) and designed to be broader than the nail shaft (2), wherein the nail shank (2), the nail tip (3) and the nail head (4) have a circular cross-section, and wherein the nail shank (2) and the nail head (4) are connected by a transition region (5) which widens towards the nail head (4) and whose annular outer surface is curved concavely towards the nail axis (X).

### CROSS-REFERENCE TO RELATED APPLICATIONS AND CLAIM TO PRIORITY

This application relates to application No. 21150547.4 filed Jan. 7, 2021 in the European Patent Office, the disclosure of which is incorporated herein by reference and to which priority is claimed.

### FIELD OF THE INVENTION

The present invention relates to a nail, in particular for use in a nail setting device, which is made of an exclusively or predominantly lignocellulosic material and has a nail shank defining a nail axis, a nail tip arranged at the front end of the nail shank and a nail head arranged at the rear end of the nail shank and designed to be broader than the nail shank.

### BACKGROUND OF THE INVENTION

Nails have been known as fasteners for a long time. They are predominantly made of metal, for example steel, aluminum, copper or the like. However, metal nails have disadvantages. For example, despite corrosion protection measures such as galvanizing, steel nails tend to rust under unfavorable conditions, especially when acidic conditions prevail in the nailed material. This is particularly true for tannin-rich woods, which are used outdoors for example for facades and terraces because of their durability. When exposed to weathering, undesirable dark to black discoloration can occur at the nailed areas. A remedy by using stainless steel grades is possible but very costly. Another disadvantage is that the recycling of wood products interspersed with steel nails is costly.

For this reason, nails made predominantly of lignocellulosic materials are used as an alternative, such as wood or woody plant material in the form of bamboo or similar. For a long time, such wooden nails could only be used if the substrate to be nailed was previously provided with a hole into which the nail was then driven. However, more recent developments make it possible to drive wooden nails directly into wood with the aid of nail setting devices such as pneumatic nailers, without pre-drilling the wood material. Reference should be made in particular to WO 2016/180900 A1 of the applicant, from which a nail strip for use in a nail setter is known, the nails of which, consisting of a nail shank and a nail tip, are made of wood or wood materials and are connected to one another by connecting means which are automatically sheared off when the nails are set. Another nail comprising a nail shank, a nail tip and a nail head, which may be made of wood, among other materials, is disclosed in DE 10 2017 100748 A1. One disadvantage of the known nails is that they are only suitable to a limited extent for attaching facade boards to a substructure, because the penetration depth of the head end into the board material cannot be determined in a defined manner and there is a risk that the facade boards will slip off over the head end. In other words, the secure hold of a facade panel attached with the known wooden nails is not sufficiently guaranteed.

### SUMMARY OF THE INVENTION

It is therefore the object of the present invention to create a nail of the type mentioned above which is suitable for fixing facade panels boards to a substructure.

To solve this problem, the present invention provides a nail of the type mentioned above, characterized in that the nail shank, the nail tip and the nail head have a circular cross-section, and that the nail shank and the nail head are connected by a transition region which widens towards the nail head and whose annular outer surface is curved concavely towards the nail axis.

Such nails are particularly suitable for fastening facade boards to a substructure, for example to a wooden structure. Due to the circular nail head, which is thicker than the shank, in combination with the widening transition area, which has a concave outer surface, i.e. curved inwards towards the nail axis, excellent pull-out properties of the nail are achieved. Furthermore, the facade panels are additionally supported by the transition area and the nail head, so that a secure hold of the facade panels on the substructure can be ensured.

The nails according to the invention with a circular cross-section can be produced in a simple manner by turning or lathe-turning from a bar material.

Preferably, the outer surface of the transition area has a circular arc section in cross-section and extends in particular over a circumferential angle of 90°. Expediently, the outer surface has a radius of curvature that is ≥0.3 mm, preferably ≥0.6 mm and particularly preferably 0.8 mm. Particularly good pull-out strengths have been achieved with radii of curvature in these ranges.

To further support the pull-out strength, it is provided that the transition region begins directly at the front end face, in particular the front outer circumferential edge of the nail head, and/or merges continuously into the nail shank.

In a further embodiment of the invention, the nail head is cylindrical in shape, the nail head having in particular a diameter of at least 5.0 mm and/or of at most 7.0 mm. Preferably, the diameter is 6.3 mm±0.3 mm. Advantageously, the diameter of the nail head is by 25% to 40% larger than the diameter of the axial end section of the nail shaft adjoining the transition region. In particular, the diameter of the nail head is 34±1% larger than the diameter of the axial rear end section of the nail shaft adjoining the transition area.

In a further embodiment of the invention, the overall length of the nail head is 1.5 mm and/or ≤4.5 mm and is in particular 3.0 to 3.2 mm. In this way, sufficient support of the facade panels boards fixed with the nails according to the invention is achieved. In addition, the comparatively high head shape counteracts breakage of the head ring surface due to the impact of the nail head during the setting process.

According to one embodiment of the invention, the nail according to the invention has an overall length of at least 50 mm and/or of at most 90 mm, in particular of at most 80 mm and particularly preferably of at most 70 mm and is preferably 60 mm. This means that the nail according to the invention can be used for all common facade panel thicknesses.

Advantageously, an axially rear end section of the nail shank adjoining the transition region has a constant diameter, which is in particular at least 3.5 mm and/or at most 5.5 mm and preferably 4.7 mm.

According to one embodiment of the present invention, the nail shank has a constant cross-section over its entire length. Accordingly, the nail can be easily driven into facade panels.

Alternatively, the nail shank can have an axial shank section adjoining the axially rear end section, on which anchoring structures are formed which each have a structure section tapering conically towards the nail tip, the anchoring structures preferably being formed in the same way. This takes account of the fact that, according to common standards in timber construction, a profiled nail shank is required for permanent static pull-out.

The anchoring structures can have a maximum structure diameter that is larger, in particular by at least 1.5% and/or by a maximum of 3% larger, preferably by 2 to 2.2% larger, than the shank diameter of the axially rear end section of the nail shank that adjoins the transition area. In a particularly preferred embodiment of the invention, the maximum structural diameter is 4.8 mm. This embodiment is particularly useful when the nail shank has a diameter of 4.7 mm in its axial end portion adjacent to the transition region.

In one embodiment of the invention, the anchoring structures have a minimum structure diameter that is smaller, in particular smaller by at least 8% and/or at most by 12%, preferably smaller by 8.3 to 8.7%, than the shank diameter of the axially rear end section of the nail shank adjacent to the transition region. Preferably, the minimum shank diameter is 4.3 mm.

A further embodiment of the embodiment with anchoring structures is characterized in that the maximum structure diameter is present in each case at the rear end, facing the nail head, of the conically tapering structure sections and the minimum structure diameter is present at their front ends.

In an advantageous further development of this embodiment, it is provided that the anchoring structures have a two-stage transition section located in the longitudinal direction behind the conically tapering structure sections, the first, rear transition stage of which has a circular segment-like cross-section and the second, front transition stage of which has a circular segment-like cross-section, the radius of curvature of the second transition stage being greater than the radius of curvature of the first transition stage, the radius of curvature of the first transition stage being in particular 0.2 mm and the radius of curvature of the second transition stage being in particular 0.25 mm.

Preferably, the total length of the anchoring structures with the conically tapering structure section and the transition section is at least 2 mm and/or at most 2.3 mm, wherein the anchoring structures preferably have a total length of 2.1 mm.

The axial shaft section on which the anchoring structures are formed can be directly adjacent to the nail tip. Alternatively, a front axial end section with a constant diameter corresponding to the shaft diameter of the axial rear end section adjoining the transition area can be provided in between. The axial length of this front end section is in particular between 0.5 and 1.5 mm and is preferably 1 mm.

The tip angle of the nail tip is preferably in the range of 60 to 120° and is in particular 90°±3°.

According to one embodiment of the present invention, it is provided that the nail is made of wood and/or a wood material, in particular an organically bonded wood material, preferably a resin-bonded laminated wood or a resin-bonded fiber composite material containing lignocellulosic fiber.

The organically bonded wood material preferably contains melamine or phenolic resin as the synthetic resin, which gives the nail particularly good stability.

The organically bonded wood-based material advantageously contains synthetic resin in an amount of at least 10% by weight, in particular at least 15% by weight, where the synthetic resin content is preferably 20% by weight.

According to one embodiment of the present invention, the nail comprises a material having a density greater than 0.65 g/cm3, in particular a density greater than 0.85 g/cm3, preferably a density greater than 1.0 g/cm3 or a density greater than 1.1 g/cm3.

Furthermore, the present invention creates a nail strip comprising a plurality of nails according to the invention. Such a nail strip can be used in a nail setting device, in particular in pneumatic nailers.

Finally, the present invention proposes to use a nail according to the invention or a nail strip according to the invention for fastening facade boards to a substructure, in particular to a wooden structure.

### BRIEF DESCRIPTION OF THE DRAWINGS

Further features and advantages of the invention are described on the basis of the following description of two embodiments of nails according to the invention with reference to the accompanying drawing. The drawing shows

FIG. 1 a front view of a nail according to one embodiment of the present invention;

FIG. 2 is a magnified view of detail II of FIG. 1;

FIG. 3 a plan view of the nail of FIG. 1;

FIG. 4 a perspective view of a nail according to a further embodiment of the present invention;

FIG. 5 a front view of the nail shown in FIG. 4;

FIG. 6 is a magnified view of section VI of FIG. 5;

FIG. 7 is a magnified view of section VII of FIG. 5; and

FIG. 8 the nail of FIG. 5 in plan view.

### DETAILED DESCRIPTION OF THE PREFERRED EMBODIMENTS

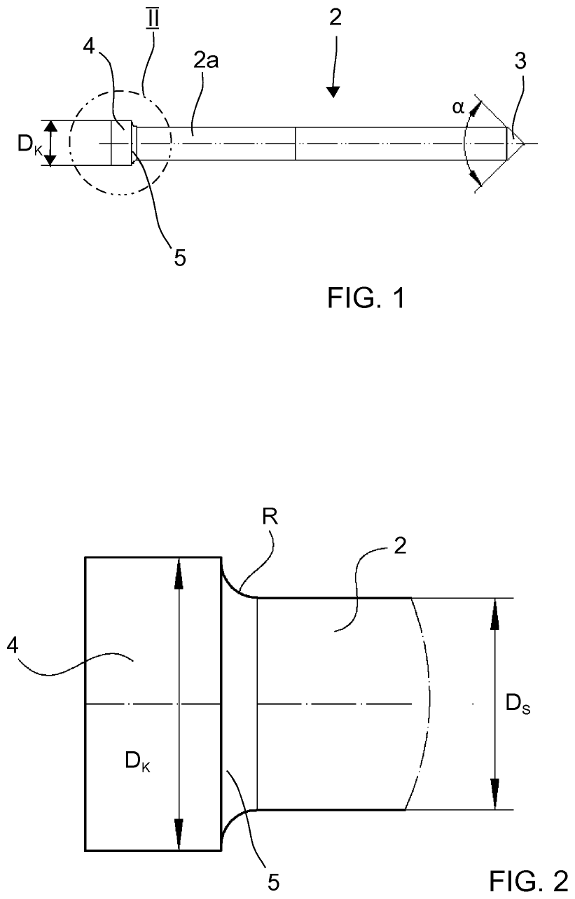

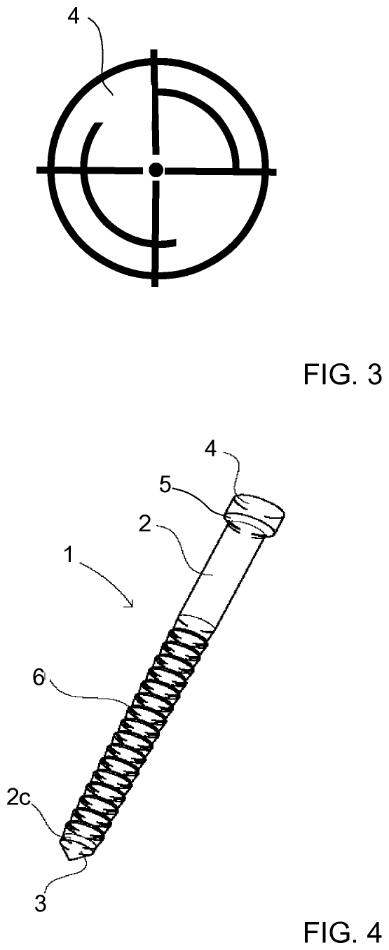

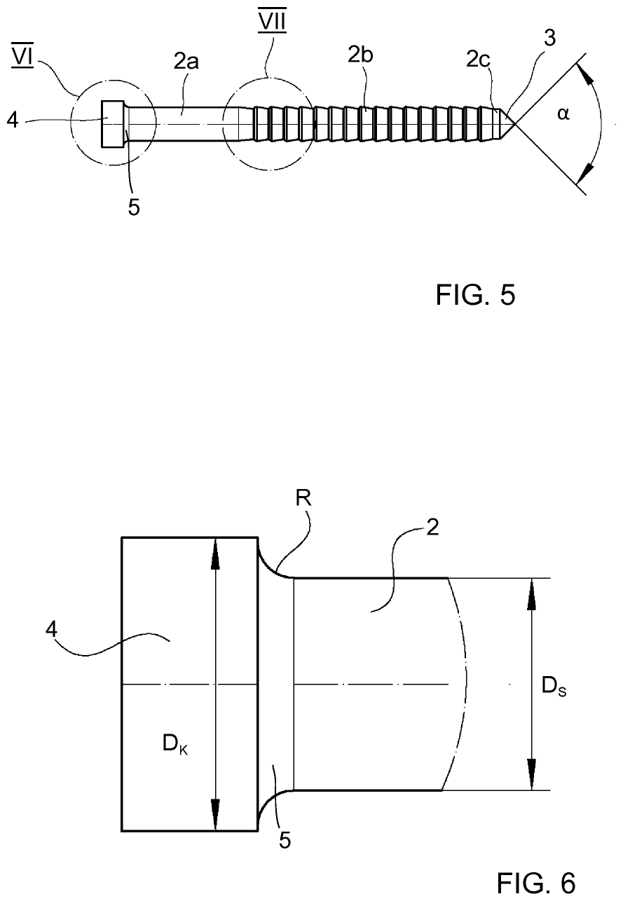

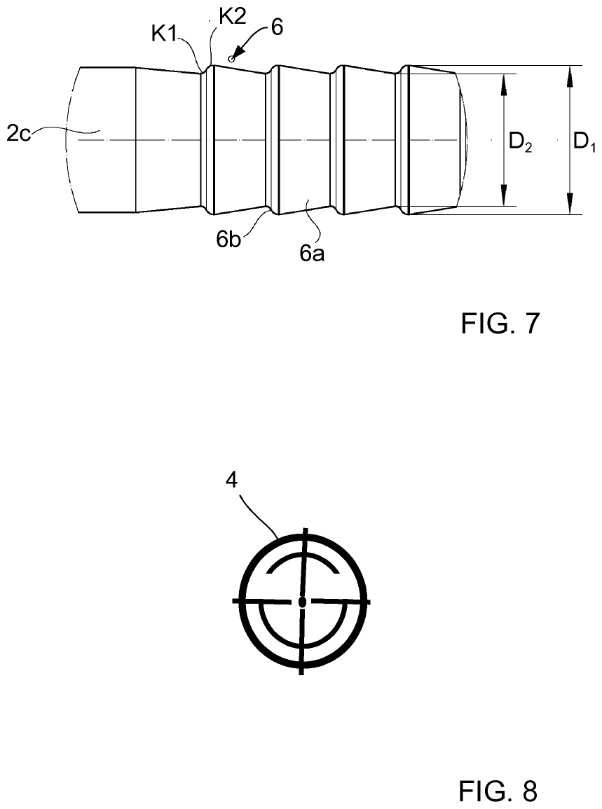

FIGS. 1 to 3 and 4 to 8 show two embodiments of a nail 1 of the present invention. The nail 1 consists of a predominantly lignocellulosic material having a density greater than 1.1 g/cm³. In the present case, the lignocellulosic material is an organically bonded wood material in the form of a synthetic resin-bonded, laminated wood which has a plurality of layers. Alternatively, the lignocellulosic material may also be a synthetic resin-bonded fiber composite material containing lignocellulosic fibers. In this embodiment, the organically bonded wood-based material contains synthetic resin in an amount of more than 15% by weight. In the present embodiment, the synthetic resin content is about 20% by weight.

The nail 1 comprises a nail shank 2 defining a nail axis X, a nail tip 3 arranged at the front end of the nail shank 2 and a nail head 4 arranged at the rear end of the nail shank 2 and widened relative thereto, wherein a transition region 5 widening towards the nail shank 2 extends between the nail shank 2 and the nail head 4. The nail shaft 2, the nail tip 3, the nail head 4 and the transition area 5 each have a circular cross-section.

The nail tip 3 is conical in shape and has a tip angle a that lies in the range of 60° and 120° and is 90°±3° in the embodiment shown. Alternatively, a ballistic nail tip 3 could be provided, the tip angle of which is measured between the front end of the nail tip 3 and the rear end of the nail tip 3 at the transition to the nail shank 2. In this case, the nail tip 3 is preferably designed to be pointed, but can also be rounded.

The nail head 4 is cylindrical and has a length of 1.5 to 4.5 mm in the longitudinal direction of the nail, in this case 3 mm. The outer diameter D_{K} of the nail head 3 is in the range of 5.0 to 7.0 mm and in the example shown is 6.3 mm. It is essential that the diameter of the nail head 4 is 25 to 40%, in particular 34±1%, larger than the diameter D_{K} of the axially rear end section of the nail shaft 2 adjacent to the transition region 5, which lies in the range between 3.5 mm and 5.5, mm and is 4.7 mm in the illustrated embodiment example.

The transition area 5 between the nail shaft 2 and the nail head 4 widens from the nail shaft 2 towards the nail head 4. The annular outer surface of the transition area 5 is curved towards the nail axis X, i.e. concavely, and in cross-section, i.e. in longitudinal section through the nail 1, the outer surface has the shape of a section of a circular arc in cross section extending over a circumferential angle of 90°. The outer surface begins directly at the front outer peripheral edge of the nail head 4 and merges continuously into the nail shank 2. Thereby, the circular arc-shaped section has a radius of curvature R, which is ≥0.3 mm, preferably ≤0.6 mm, and is 0.8 mm in the illustrated embodiment example.

The nail 1 has an overall length in the range of 50 mm and 90 mm, the overall length being 58 mm in the illustrated embodiment example.

In the nail 1 shown in FIGS. 1 to 3, the nail shank 2 has a constant diameter over its entire length.

The embodiment of the nail 1 according to the invention shown in FIGS. 4 to 8 differs from the embodiment shown in FIGS. 1 to 3 only in that the nail shank 2 is not smooth with a constant cross-section over its entire length. Rather, only the rear end section 2a of the nail shank 2 adjoining the transition area 5 is smooth with a constant diameter of 4.7 mm in this case. This axially rear end section 2a extends over a distance of 15 mm.

The axial shank section 2b adjoining this axially rear end section 2 in the direction of the nail tip 3 does not have a smooth outer surface. Rather, anchoring structures 6 are formed on this axial shaft section 2b, each of which has a structure section 6a tapering conically towards the nail tip 3 and a transition section 6b adjoining it at the rear. A total of 15 such anchoring structures 6 are provided on the axial shaft section, each of which is formed in the same way.

Specifically, the anchoring structures 6 have a maximum structural diameter D1 that is larger than the shank diameter D_{S} of the rear end section 2a of the nail shank 2 that adjoins the transition section 5. In this case, the maximum structure diameter D₁ should be at least 1.5% and/or at most 3% larger than the shank diameter of the rear end section 2a of the nail shank 2. In the illustrated embodiment example, the maximum structure diameter D₁ is 4.8 mm and is located in each case at the rear end of the conically tapering structure sections 6a facing the nail head 4. In other words, the maximum structure diameter D₁ is 2.1% larger than the shank diameter D_{S} of the axial rear end portion 2a of the nail shank 2.

The anchoring structures 6 have a minimum structure diameter D₂ at the front ends of the conically tapering structure sections 6a, which is smaller than the shaft diameter D_{S} at the rear end section 2a of the nail shaft 2 that adjoins the transition area 5. In this case, the minimum structural diameter D₂ should be smaller than the shaft diameter D_{S} of the axially rear end section of the nail shaft 2 by at least 8% and/or at most 12%. In the illustrated embodiment example, the minimum shank diameter D₂ is 4.3 mm, so that it is 8.5% smaller than the shank diameter D_{S}.

The transition sections 6b located on the rear sides of the conically tapering structural sections 6a facing the nail head 4 are formed in two stages, the transition stages each having a circular segment-like cross section. The radius of curvature K₁ of the second transition stage is larger than the radius of curvature K₁ of the first transition stage. In the example shown, the radius of curvature K₁ of the first transition stage is 0.2 mm and the radius of curvature K₂ of the second transition stage is 0.25 mm.

Between the axial shank section 2b, on which the anchoring structures 6 are formed, and the nail tip 3 lies a further front end section 2c with a constant outer diameter, which corresponds to the shank diameter of the axially rear end section 2a of the nail shank 2 adjoining the transition area 5 and has an axial length of 0.5 to 1.5 mm, here 1 mm.

The nails 1 according to the invention can be made from a solid material, in particular a bar material, by turning or lathe work.

I claim:

1. Nail, in particular for use in a nail setting device, of an exclusively or predominantly lignocellulosic material and has a nail shaft (2) defining a nail axis (X), a nail tip (3) arranged at the front end of the nail shaft (2) and a nail head (4) arranged at the rear end of the nail shaft (2) and designed to be broader than the nail shaft (2), wherein the nail shank (2), the nail tip (3) and the nail head (4) have a circular cross-section, and wherein the nail shank (2) and the nail head (4) are connected by a transition region (5) which widens towards the nail head (4) and whose annular outer surface is curved concavely towards the nail axis (X).

2. Nail according to claim 1, wherein the outer surface of the transition region (5) is formed in the shape of a section of a circular arc in cross-section and extends in particular over a circumferential angle of 90°, the outer surface having in particular a radius of curvature (R) which is 0.3 mm, preferably 0.6 mm, and particularly preferably 0.8 mm.

3. Nail according to claim 1, wherein the transition region (5) begins directly at the front end face, in particular the front outer circumferential edge of the nail head (4) and/or merges continuously into the nail shank (2).

4. Nail according to claim 1, wherein the nail head (4) has a diameter (D_{K}) of at least 5 mm and/or of at most 7.0 mm and the diameter (D_{K}) is preferably 6.3 mm±0.3 mm and/or wherein the diameter (D_{K}) of the nail head (4) is by 25% to 40%, in particular by 34±1% larger than the diameter of an axially rear end section (2a) of the nail shaft (2) adjoining the transition region (5) and/or the total length of the nail head is ≥1.5 mm and/or ≤4.5 mm and in particular is 3 mm to 3.2 mm.

5. Nail according to claim 1, wherein the nail has an overall length of at least 50 mm and/or of at most 90 mm, in particular of at most 80 mm and especially preferably of at most 70 mm, and the overall length is preferably 58 mm, and/or in that the point angle (α) of the nail point (3) is in the range from 60 to 120° and in particular is 90°±3°.

6. Nail according to claim 1, wherein an axially rear end section (2a) of the nail shank (2) adjoining the transition region (5) has a constant diameter (Ds) which is in particular at least 3.5 mm and/or at most 5.5 mm and preferably 4.7 mm.

7. Nail according to claim 1, wherein the nail shank (2) has a constant circular cross-section over its entire length.

8. Nail according to claim 6, wherein the nail shank (5) has an axial shank section (2b) adjoining the axially rear end section (2a), on which anchoring structures (6) are formed which each have a structure section (6a) tapering conically towards the nail tip (3), the anchoring structures (6) preferably being formed in the same way.

9. Nail according to claim 8, wherein the anchoring structures have a maximum structure diameter (D₁) which is larger, in particular by at least 1.5% and/or by a maximum of 3% larger, preferably by 2 to 2.2% larger, than the shank diameter (D_{S}) of the axially rear end portion (2a) of the nail shank (2) which adjoins the transition region (5), the maximum structure diameter (D₁) being in particular 4.8 mm.

10. Nail according to claim 8, wherein the anchoring structures (6) have a minimum structure diameter (D₂) which is smaller, in particular smaller by at least 8% and/or at most 12%, preferably smaller by 8.3 to 8.7%, than the shank diameter (D_{S}) of the axially rear end portion (2a) of the nail shank (2) which adjoins the transition region (5), the minimum shank diameter (D₂) preferably being 4.3 mm.

11. Nail according to claim 9, wherein the maximum structure diameter (D1) is present at the rear end of the conically tapering structure sections (6a) facing the nail head (2) and the minimum structure diameter (D₂) is present at the front ends thereof.

12. Nail according to claim 11, wherein the anchoring structures (6) each have a two-stage transition section (6b) lying in the longitudinal direction behind the conically tapering structure sections, the first, rear transition stage of which has a circular-segment-like cross-section and the second, front transition stage of which has a circular-segment-like cross-section, the radius of curvature (K₂) of the second transition stage being greater than the radius of curvature (K₁) of the first transition stage, the radius of curvature (K₁) of the first transition stage being in particular 0.2 mm and the radius of curvature (K₂) of the second transition stage being in particular 0.25 mm, and/or wherein the total length of the anchoring structures (6) with the conically tapering structure section (6a) and the transition section (6b) is at least 2 mm and/or at most 2.3 mm and in particular the anchoring structures (6) have an overall length of 2.1 mm, and/or
that between the axial shank portion (2b), on which the anchoring structures (6) are formed, and the nail tip (3) a front end portion (2c) of the nail shank (2) with a constant diameter corresponding to the diameter of the rear axial end portion (2a) is provided, wherein in particular the axial length of the front axial end portion (2a) is between 0.5 and 1.5 mm and is preferably 1 mm.

13. Nail according to claim 1, wherein the nail is made of wood and/or a wood material, in particular an organically bonded wood material, preferably a synthetic resin-bonded laminated wood or a synthetic resin-bonded fiber composite material containing lignocellulosic fiber, wherein the organically bonded material contains in particular melamine or phenolic resin as synthetic resin and/or the organically bonded wood material contains synthetic resin in particular in an amount of at least 10% by weight, in particular of at least 15% by weight, the synthetic resin content preferably being 20% by weight, and/or wherein the nail consists of a material having a density greater than 0.65 g/cm³, in particular a density greater than 0.85 g/cm³, preferably a density greater than 1.0 g/cm³ or a density greater than 1.1 g/cm³.

14. Nail strip comprising a plurality of nails according to claim 1.

15. Use of a nail according to claim 1 for fastening facade boards to a substructure.

16. Nail according to claim 2, wherein the transition region (5) begins directly at the front end face, in particular the front outer circumferential edge of the nail head (4) and/or merges continuously into the nail shank (2).

17. Nail according to claim 2, wherein the nail shank (2) has a constant circular cross-section over its entire length.

18. Nail according to claim 3, wherein the nail shank (2) has a constant circular cross-section over its entire length.

19. Nail according to claim 4, wherein the nail shank (2) has a constant circular cross-section over its entire length.

20. Nail according to claim 5, wherein the nail shank (2) has a constant circular cross-section over its entire length.
